(19) United States
(12) Patent Application Publication
(10) Pub. No.: US 2023/0036450 A1
(43) Pub. Date: Feb. 2, 2023

(54) Improving angular resolution of radars using an artificial neural network

(71) Applicant: Teknologian tutkimuskeskus VTT Oy, Espoo (FI)

(72) Inventors: Otto Korkalo, Espoo (FI); Paul Kemppi, Espoo (FI); Petri Honkamaa, Espoo (FI); Tero Kiuru, Espoo (FI); Mervi Hirvonen, Espoo (FI)

(21) Appl. No.: 17/792,424

(22) PCT Filed: Jan. 14, 2021
(86) PCT No.: PCT/FI2021/050021

§ 371 Date: Jul. 13, 2022

(30) Foreign Application Priority Data
Jan. 17, 2020 (FI) 20205054

(51) Int. Cl. G06N 3/08; G01S 13/89

(52) U.S. Cl. CPC G06N 3/08; G01S 13/89

(57) ABSTRACT

According to an example aspect of the present invention, there is provided a method comprising, receiving, from a radar, a first reflected signal and a second reflected signal, determining a reference signal of the first reflected signal and training an artificial neural network using the first reflected signal and the reference signal of the first reflected signal, upon training, determining an output of the artificial neural network associated with the first reflected signal and providing a magnitude and angle image of the radar associated with the second reflected signal based on the output of the artificial neural network associated with the first reflected signal.

### FIELD

Embodiments of the present invention relate in general to radars and more specifically to improving angular resolution of radars using an artificial neural network.

### BACKGROUND

Radars may be used for detecting various objects by exploiting characteristics of radio waves. For example, a distance or direction to an object may be estimated using radars. In addition, radars may be utilized for estimating a speed of an object. Radars typically use radio waves at frequencies ranging from 30 Hz to 300 GHz. Thus, radars are capable of sensing in all environmental conditions, such as, in direct sunlight, darkness, smoke, rain or dust. However, compared to optical sensors, such as, lidars, a drawback associated with the use of radars is that an angular resolution of a radar may be a problem for some applications and massive antenna systems may be needed for achieving good angular resolution. There is therefore a need to provide an improved apparatus, method and computer program for achieving better angular resolution without increasing the size of a radar.

### SUMMARY OF THE INVENTION

According to some aspects, there is provided the subject-matter of the independent claims. Some embodiments are defined in the dependent claims.

According to a first aspect of the present invention, there is provided a method comprising receiving, from a radar, a first reflected signal and a second reflected signal, determining a reference signal of the first reflected signal and training an artificial neural network using the first reflected signal and the reference signal of the first reflected signal, upon training, determining an output of the artificial neural network associated with the first reflected signal and providing a magnitude and angle image of the radar associated with the second reflected signal based on the output of the artificial neural network associated with the first reflected signal.

Embodiments of the first aspect may comprise at least one feature from the following bulleted list:
the method may be for an apparatus comprising the artificial neural network;
the method may further comprise transmitting the second reflected signal as an input to the artificial neural network and receiving the output of the artificial neural network, wherein the output comprises the magnitude and angle image of the radar associated with the second reflected signal;
the magnitude and angle image of the radar associated with the second reflected signal may be determined by the artificial neural network using an algorithm modelled by the artificial neural network during said training;
the method may further comprise receiving the reference signal from a three-dimensional sensor, the three-dimensional sensor being associated with the radar;
the method may further comprise determining the reference signal from a simulated reference signal;
the method may further comprise determining a difference between an output of the artificial network associated with the first reflected signal and the reference signal and training the neural network using the difference;
the method may further comprise training the artificial neural network by providing the first reflected signal to an input layer of the artificial neural network and determining the output of the artificial network associated with the first reflected signal from an output layer of the artificial neural network;
the output of the artificial neural network may comprise an indication about at least one algorithm selected by the artificial neural network, the method further comprising, determining the magnitude and angle image of the radar associated with the second reflected signal based on the at least one algorithm selected by the artificial neural network;
the at least one algorithm may comprise a mirroring algorithm, the Burg algorithm, interpolation and/or extrapolation;
the output of the artificial neural network may comprise at least one parameter selected by the artificial neural network for the at least one algorithm, the method further comprising determining the magnitude and angle image of the radar associated with the second reflected signal based on the at least one parameter;
an output of a first algorithm associated with the second reflected signal may be weighted by a first weight and an output of a second algorithm may be weighted by a second weight and the magnitude and angle image of the radar may be determined by combining the weighted output of the first algorithm and the weighted output of the second algorithm;
the first weight and the second weight may be modelled by the artificial neural network.

According to a second aspect of the present invention, there is provided an apparatus comprising a processor, wherein the processor is configured to perform the method of the first aspect.

According to a third aspect of the present invention, there is provided a computer program configured to perform the method of the first aspect.

### BRIEF DESCRIPTION OF THE DRAWINGS

FIG. 1 illustrates operation of an exemplary radar system in accordance with at least some embodiments of the present invention;

FIG. 2 illustrates operation of a radar and a sensor in accordance with at least some embodiments of the present invention;

FIG. 3 illustrates an example apparatus capable of supporting at least some embodiments of the present invention;

FIG. 4 illustrates a process in accordance with at least some embodiments of the present invention;

FIG. 5 illustrates a flow graph of a method in accordance with at least some embodiments of the present invention.

### EMBODIMENTS

Performance of a radar may be measured and evaluated by considering an angular resolution of the radar. In general, the angular resolution of the radar may be referred to as a minimum distance at which the radar is capable of differentiating two objects, or targets, which are of the same size. Angular resolution of radars may be improved by the procedures described herein. In accordance with embodiments of the present invention, an artificial neural network may be trained and exploited for increasing angular resolution of radars, thereby enabling better performance without increasing costs significantly.

The angular resolution may depend on a number of channels used and bandwidth extrapolation for example. Channel data may be extrapolated and interpolated for creating virtual channels, to improve the angular resolution of a radar. Final image, such as a magnitude and angle image of the radar, may be constructed in a beamforming process and it may depend greatly on the number of channels, i.e., array elements, used.

The angular resolution of the radar may be improved by using Multiple-Input Multiple-Output, MIMO, technology. For example, time domain MIMO, frequency domain MIMO and full MIMO systems may be utilized. However, the drawback of MIMO systems is that special radar hardware is required. Also, MIMO systems tend to be complex. Embodiments of the present invention therefore provide a way for improving the angular resolution of the radar without, or in addition, to MIMO for example. Moreover, faster design and testing of new configurations may be enabled and there is no need for tuning system parameters manually or to test existing algorithms, as the artificial neural network may be used to automatically find the best solution for the scenario at hand.

Angular resolution plays an increasingly important role for imaging radars. Important applications may be found in relation to automotive, aviation, robotics, people tracking and life sign monitoring. Moreover, in many cases constrains for a size of a radar, complexity and latency may be strict. Traditionally, the angular resolution of the radar is limited by the size of an aperture of a receive antenna array. Large physical size and complex structures are therefore needed for achieving good angular resolution.

At least in the contexts of automotive and aviation, there is a clear need for identifying and separating, closely spaced objects, such as, other vehicles and pedestrians. In automotive and aviation related applications distances between radars and objects, i.e., detection distances, may be long while limitations for physical dimensions and mass may be stringent due to wind load. Similar challenges may arise in the contexts of robotics and drones. In addition, robots and drones may have additional limitations for power consumption. Moreover, similar issues need to be tackled for people tracking and life sign monitoring applications as well. In consumer markets, such as, home care and smart office, cost-efficiency may also be a key factor. So in many applications high angular resolution is desired but hardware may be limited. Digital solutions may be therefore preferred.

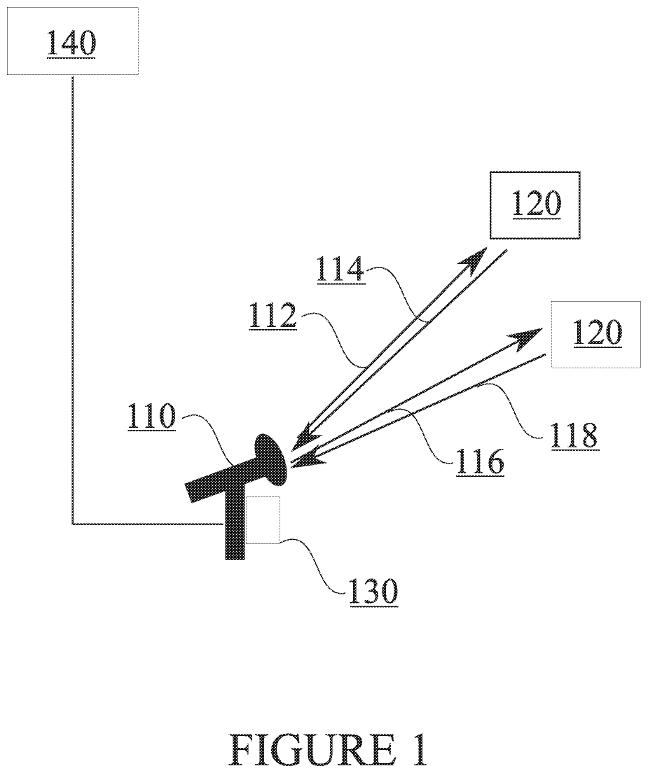

FIG. 1 illustrates operation of an exemplary radar system in accordance with at least some embodiments of the present invention. The exemplary radar system of FIG. 1 may comprise radar 110, object 120, sensor 130 and apparatus 140. Apparatus 140 may be for a radar, such as a computer configured to provide a magnitude and angle image of radar 110. In some embodiments, apparatus 140 may comprise, or be connected to, an artificial neural network. Depending on the application, object 120 may be for example a car, airplane, ship or human. Naturally, object 120 may be any other object detectable by radar 110 as well and the embodiments of the present invention are not limited to any specific object 120.

Radar 110 may comprise a transmitter and the transmitter may comprise means for transmitting, or be configured to transmit, at least one first electromagnetic signal 112 over air interface via at least one transmit antenna. Thus, the transmitter may comprise, or be connectable, to the at least one transmit antenna. In case of two or more transmit antennas, said two or more transmit antennas may form a transmit antenna array. The transmitter may receive information associated with electromagnetic signal 112 from a processing unit of radar 110. If apparatus 140 is a control device of radar 110, e.g., a computer connectable to radar 110, apparatus 140 may transmit the information associated with electromagnetic signal 112 to radar 110.

The at least one transmit antenna may be referred to as a physical antenna as well. In some embodiments, the at least one transmit antenna may comprise at least two antennas, such as a microstrip antennas or a subarray, which may be used for radiating different first electromagnetic signals 112. For example, multiple transmit antennas may be arranged in columns and/or rows, i.e., vertically and/or horizontally, to form the transmit antenna array, forming multiple transmit channels correspondingly.

At least one first electromagnetic signal 112 may be radiated into space by the at least one transmit antenna. Radar 110 may also comprise a receiver. At least one first electromagnetic signal 112 transmitted by radar 110 may hit object 120 and thus get reflected back to radar 110. Reflected electromagnetic signal of at least one first electromagnetic signal 112, i.e., at least one first reflected signal 114, may be hence referred to as an echo signal as well.

The receiver may comprise means for receiving, or be configured to receive, at least one first reflected signal 114 over air interface via at least one receive antenna. The at least one receive antenna may be referred to as a physical, real antenna as well. In some embodiments, the at least one receive antenna may comprise at least two receive antennas, such as microstrip antennas or a subarray, which may be used for receiving different versions of at least one first reflected signal 114. If the at least one receive antenna comprises at least two receive antennas, said at least two receive antennas may form a receive antenna array. Hence, the receiver may be used for receiving at least two different versions of at least one first reflected signal 114 via the at least two antennas. The receiver may forward information associated with the received at least one first reflected signal 114, such as a phase and amplitude, to apparatus 140. In other words, radar 110 may transmit at least one first reflected signal 114 upon reception to apparatus 140.

In general, an antenna array comprising multiple antennas in a horizontal or a vertical direction may be referred to as a 1-dimensional antenna array and an antenna array comprising multiple antennas in both, horizontal and vertical, directions may be referred to as a 2-dimensional antenna array. The at least one transmit antenna may be used as the at least one receive antenna as well.

In some embodiments, radar 110 may be a Frequency-Modulated Continuous Wave, FMCW, radar. In case of a FMCW radar, the transmitter may transmit more than one electromagnetic signal 112 with the same transmission power but the FMCW radar may change a frequency of transmission during the process. That is to say, the FMCW radar may exploit frequency modulation. Alternatively, in some embodiments, radar 110 may be a pulse radar or an Orthogonal Frequency Division Multiplexing, OFDM, radar, or any other arbitrary waveform radar.

Sensor 130 may be an optical sensor, such as a three-dimensional, 3D, sensor. For instance, sensor 130 may be a Lidar. In some embodiments, sensor 130 may provide one reference signal for each first reflected signal 114. That is to say, sensor 130 may provide a ground truth for each first reflected signal 114. The reference signal associated with first reflected signal 114 may be transmitted from sensor 130 to apparatus 140. Apparatus 140 may then determine the reference signal associated with first reflected signal 114 from the received reference signal. Sensor 130 may be used for example to get a highly accurate reference signals in various environments.

In some embodiments, radar 110 may be positioned in a certain location in a known environment, e.g., in a room full of boxes. If radar 110 is positioned in a certain location, the reference signal may be known beforehand and the reference signal may be the ground truth for the certain location. Location of radar 110 may be changed so that it is positioned in multiple certain locations in known environments, for training an artificial neural network by apparatus 140.

Alternatively, in some embodiments, apparatus 140 may determine the reference signal of each first reflected signal 114 without receiving any information from sensor 130, e.g., if there is no sensor 130. In such a case, apparatus 140 may determine the reference signal associated with each first reflected signal 114 from a simulated reference signal for example. That is to say, the reference signal may be generated by modelling how signals transmitted and received by radar 110 would behave in certain environments, e.g., by modelling reflections and refractions. Multiple reference signals may be generated by modelling how signals transmitted and received by radar 110 would behave in various environments. The simulated reference signal may be generated purely by simulation to avoid physical implementation for training purposes only.

In some embodiments, the reference signal may be determined from the simulated reference and the reference signal received from sensor 130, to further improve the accuracy of the reference signal.

Upon reception of first reflected signal 114 and determining the reference signal associated with first reflected signal 114, apparatus 140 may train an artificial neural network using first reflected signal 114 and the reference signal associated with first reflected signal 114. Naturally, in some embodiments, there may be multiple first reflected signals 114 and corresponding reference signals, wherein each first reflected signal 114 may be associated with a particular reference signal, to be used for training the artificial neural network.

At some point after training the artificial neural network, radar 110 may transmit at least one second electromagnetic signal 116 over air interface. Again, at least one second electromagnetic signal 116 transmitted by radar 110 may hit object 120, possibly in a different location, or some other object, and thus at least one second electromagnetic signal 116 may get reflected back to radar 110. Consequently, a reflected electromagnetic signal of at least one second electromagnetic signal 116, i.e., at least one second reflected signal 118, may be received by radar 110.

Then, at least one second reflected signal 118 may be transmitted from radar 110 to apparatus 140 as well. Upon receiving at least one second reflected signal 118, apparatus 140 may determine an output of the artificial neural network associated with first reflected signal 114, wherein the output may be determined upon training the artificial neural network with first reflected signal 114. Apparatus 140 may then provide, based on the output of the artificial neural network, a magnitude and angle image of radar 110 associated with second reflected signal 118. The magnitude and angle image of radar 110 associated with second reflected signal 118 may be provided to a user by displaying the magnitude and angle image on a screen or a user interface of apparatus 140.

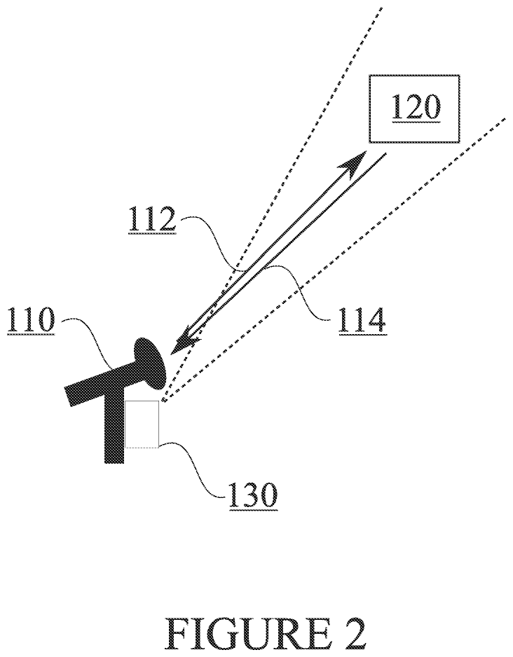

FIG. 2 illustrates operation of a sensor in accordance with at least some embodiments of the present invention. FIG. 2 shows an example of operation of sensor 130 of FIG. 1. In some embodiments, sensor 130 may be associated with radar 110. That is to say, sensor 130 may be coupled with radar 110 or connected to radar 110. Sensor 130 may be in the same location as radar 110 or in close proximity of radar 110 so that sensor 130 may provide reference signals for electromagnetic signals transmitted and received by radar 110.

As shown in FIG. 2, sensor 130 may be directed towards object 120, thereby enabling accurate information by direct observation. For instance, if sensor 130 is a Lidar, a narrow laser beam may be used to get a high-resolution picture of object 120 as an output. The output of sensor 130 may be used as a ground truth for first reflected signal 114. The ground truth generated by sensor 130 may be then used as a reference signal associated with first reflected signal 114, i.e., the reference signal of first reflected signal 114, for training of the artificial neural network.

The artificial neural network may comprise a collection of artificial neurons. Said artificial neurons may be connected. In some embodiments, each artificial neuron may be on a certain layer. If the artificial neural network comprises layers, such as an input layer, an output layer and at least one intermediate layer between the input layer and the output layer, artificial neurons on the input layer may be able to transmit signals to artificial neurons on the at least one intermediate layer and the artificial neurons on the at least one intermediate layer may be further able to transmit signals to artificial neurons on the output layer. Thus, in some embodiments, the artificial neural network may comprise multiple intermediate layers.

Artificial neurons on the input layer may receive input, such as first reflected signal 114. Then, said artificial neurons on the input layer may compute a signal based on the input, e.g., a real number, and transmit the computed signal to artificial neurons on the intermediate layer. Said artificial neurons on the intermediate layer may also compute a signal, e.g., a real number, based on the received signals and transmit the computed signal to artificial neurons on the output layer. Finally, said artificial neurons on the output layer may compute output signals based on the signals received from the intermediate artificial neurons. The output signals may be combined to generate an output of the artificial neural network. The output of the artificial neural network may be for example a signal or an algorithm for radar 110 that can be used to provide a magnitude and angle image of radar 110.

Each artificial neuron may be associated with one or more activation function(s), such as non-linear function(s), and each activation function may be associated with a weight. An output of each artificial neuron may be computed using the activation function(s) and associated weight(s) for the artificial neuron in question. In the beginning of the training of the artificial neural network the activation function(s) and weight(s) may be set to some initial values. Said initial values may be defined by a user for example. In some embodiments, the activation function(s) may be predefined and the activation function(s) may not change. The training process may be used to find such weight(s) for the activation function(s) that give an output which is as close to the reference signal of first reflected signal 114 as possible. In some embodiments, the training process may be used to select at least one algorithm for radar 110.

The training process may start when first reflected signal 114 is fed to the artificial neurons on the input layer of the artificial neural network. Each artificial neuron on the input layer may compute a signal using its own function(s) and associated weight(s) with received first reflected signal 114. Then, each artificial neuron on the input layer may transmit the computed signal to all artificial neurons on the intermediate layer of the artificial neural network. Each artificial neuron on the intermediate layer may compute a signal using its own function with the signals received from the artificial neurons on the input layer and transmit the computed signal to all artificial neurons on the output layer. Each artificial neuron on the output layer may compute a signal using its own function with the signals received from the artificial neurons on the intermediate layer. The signals computed by the artificial neurons on the output layer may then be computed to determine an output of the artificial neural network. In some embodiments, there may be more than one intermediate layer.

The output of the artificial neural network may be compared to a desired output. For instance, if radar 110 is in a certain location in a known environment, the desired output, such as the reference signal of first reflected signal 114, may be known. Thus, the output of the artificial neural network may be compared to the desired output to determine an error rate. The error rate may be used to adjust weight(s) of the activation function(s) of the artificial neurons.

Different algorithms for improving resolution of radar 110 may work differently in different environments and for different objects. The artificial neural network may thus function as a classifier so that depending on the environment and the object, i.e., the input signal, the artificial neural network may choose an algorithm for radar 110, the selected algorithm being such that it gives the most accurate result. During training outputs of different algorithms for radar 110 may be compared to different objects and weight(s) of the activation function(s) may be updated accordingly.

So based on the training with first reflected signal 114, the artificial neural network may for example select at least one algorithm for radar 110 as the output associated with first reflected signal 114. The at least one algorithm may be for example a mirroring algorithm described in Finnish patent application 18206721.5, the Burg algorithm, interpolation algorithm and/or extrapolation algorithm. That is to say, the neural network may select at least one algorithm which provides the highest angular resolution in one, known environment. In embodiments of the present, an algorithm refers to an algorithm for radar 110, such the mirroring algorithm, the Burg algorithm, interpolation algorithm or extrapolation algorithm.

In some embodiments, the artificial neural network may look for parameters for at least one algorithm selected for radar 110. For instance, if the error rate is small, the artificial neural network may be trained to find, or determine, at least one parameter for the selected algorithm. The at least one parameter may be for example input dimensions parameter or estimation order parameter. So based on the training with first reflected signal 114, the artificial neural network may for example select at least one parameter for the at least one algorithm selected for radar 110 as the output associated with first reflected signal 114.

Hence, it is possible to find best possible parameters for each of the algorithms using different inputs. Different resolution improvement algorithms may work differently with different inputs. Some algorithms may perform worse, some better, depending on different input. In addition, parameters associated with a certain algorithm may be selected so that the best possible resolution can be provided.

Alternatively, or in addition, the artificial neural network may determine a common algorithm for radar 110. The common algorithm may be suitable for various environments and provide the highest angular resolution for radar 110 in general. For instance, radar 110 may be positioned in a first environment and the common algorithm may be used in the first environment. Then, radar 110 may be moved to a second environment and the common algorithm may be used in the second environment as well. So at least one algorithm providing the best performance in both, the first and the second, environments may be selected as the common algorithm. The common algorithm may take inputs from various environments and thus, operation of the system is optimal regardless of the environment. The common algorithm may be generated along with the parameters.

So if second reflected signal 118 is fed, or transmitted, to the artificial neural network, the parameters associated with the common algorithm may be used to provide a magnitude and angle image of radar 110 associated with second reflected signal 118. The parameters of the common algorithm may not be optimal for either, the first or the second environment, but such parameter may provide reasonable error rates for the first and second environments, or some other environments as well. If the artificial neural network is large enough, the output of the artificial neural network may be ideal in all environments. The common algorithm may be referred to as an algorithm modelled by the artificial neural network as well.

Moreover, in some embodiments, the artificial neural network may provide weights for at least one algorithm. For instance, if a first algorithm is the mirroring algorithm and a second algorithm is the Burg algorithm, the artificial neural network may determine a first weight and a second weight, the first weight being for the first algorithm and the second weight being for the second algorithm. For instance, the first weight may be set as 0.4 (40%) and the second weight may be set as 0.6 (60%) and an error rate may be determined based on the output of the artificial neural network. After that, the first weight may be set as 0.6 and the second weight may be set as 0.4 and a second error rate may be determined. If the first error rate is smaller than the second error rate, the first weight may be set as 0.4 and the second weight may be set as 0.6. In some embodiments, the training may be continued by using various weights until a desired error rate is achieved.

So the artificial neural network may select a first and a second algorithm during the training and also suitable weights for the first and the second algorithm as the output associated with first reflected signal 114. The first weight and the second weight may be modelled by the artificial neural network to optimize the performance of radar 110.

Said weights may be updated depending on the situation. In some embodiments, the artificial neural network may select the algorithms for second reflected signal 118 and provide as an output the selected algorithms, and possibly the weights as well, to apparatus 140. Apparatus 140 may then determine the magnitude and angle image of radar 110 associated with second reflected signal 118 using the algorithms and the weights.

Embodiments of the present invention therefore enable increased angular resolution of radars without increasing costs significantly by using an artificial neural network. The artificial neural network may be trained in various ways to provide the best resolution for one certain environment or multiple environments.

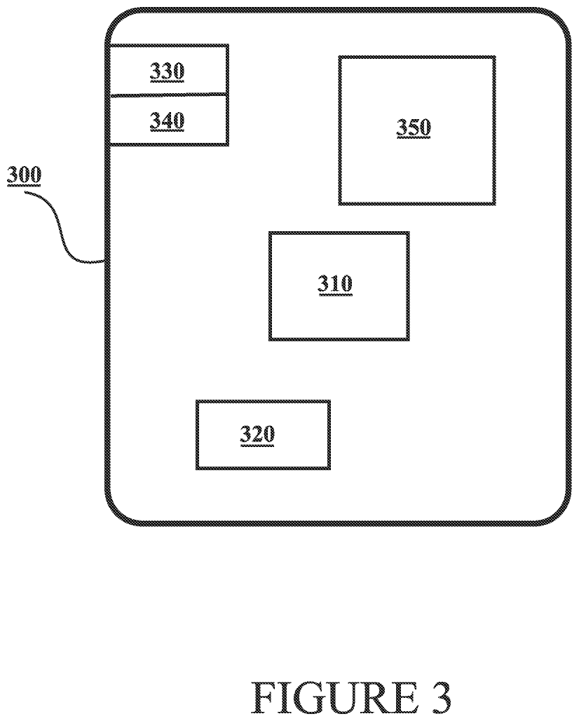

FIG. 3 illustrates an example apparatus capable of supporting at least some embodiments of the present invention. Illustrated is apparatus 300, which may comprise or correspond to apparatus 140 of FIG. 1. That is to say, apparatus 300 may also be for radar 110, e.g., a control device configured to control the functioning of radar 110 or analysing and providing output of radar 110.

Comprised in apparatus 300 may be processing unit, i.e., processing element, 310, which may further comprise, for example, a single- or multi-core processor wherein a single-core processor comprises one processing core and a multi-core processor comprises more than one processing core. Processing unit 310 may comprise, in general, a control device. Processing unit 310 may comprise one or more processors. Processing unit 310 may be a control device. A processing core may comprise, for example, a Cortex-A8 processing core manufactured by ARM Holdings or a Steamroller processing core produced by Advanced Micro Devices Corporation. Processing unit 310 may comprise at least one Qualcomm Snapdragon and/or Intel Atom processor. Processing unit 310 may comprise at least one Application-Specific Integrated Circuit, ASIC. Processing unit 310 may comprise at least one Field-Programmable Gate Array, FPGA. Processing unit 310 may be means for performing method steps in apparatus 300. Processing unit 310 may be configured, at least in part by computer instructions, to perform actions.

Apparatus 300 may comprise memory 320. Memory 320 may comprise Random-Access Memory, RAM, and/or permanent memory. Memory 320 may comprise at least one RAM chip. Memory 320 may comprise solid-state, magnetic, optical and/or holographic memory, for example. Memory 320 may be at least in part accessible to processing unit 310. Memory 320 may be at least in part comprised in processing unit 310. Memory 320 may be means for storing information, such as a phase and amplitude of a reflected signal. Memory 320 may comprise computer instructions that processing unit 310 is configured to execute. When computer instructions configured to cause processing unit 310 to perform certain actions are stored in memory 320, and apparatus 300 overall is configured to run under the direction of processing unit 310 using computer instructions from memory 320, processing unit 310 and/or its at least one processing core may be considered to be configured to perform said certain actions. Memory 320 may be at least in part comprised in processing unit 310. Memory 320 may be at least in part external to apparatus 300 but accessible to apparatus 300.

Apparatus 300 may comprise a transmitter 330. The transmitter 330 may comprise at least one transmit antenna, or the transmitter 330 may be connectable to the at least one transmit antenna. If apparatus 300 is a control device for radar 110, the transmitter 330 may be connectable to radar 110 or to the at least one antenna via radar 110.

Apparatus 300 may also comprise a receiver 340. The receiver may comprise at least one receive antenna, or the receiver may be connectable to the at least one receive antennas, forming at least two receive channels correspondingly. If apparatus 300 is a control device for radar 110, the receiver 330 may be connectable to radar 110 or to the at least one antenna via radar 110.

Apparatus 300 may also comprise a user interface, UI, 350. UI 350 may comprise at least a display or a touchscreen. A user may be able to operate apparatus 300 via UI 350. Also, UI 350 may be used for displaying information to the user. For example, UI 350 may be used for providing, i.e., displaying, a magnitude and/or angle image of radar 110.

Processing unit 310 may be furnished with a transmitter arranged to output information from processing unit 310, via electrical leads internal to apparatus 300, to other devices comprised in apparatus 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processing unit 310 may comprise a receiver arranged to receive information in processing unit 310, via electrical leads internal to apparatus 300, from other devices comprised in apparatus 300. Such a receiver may comprise a serial bus receiver arranged to, for example, receive information via at least one electrical lead from receiver 340 for processing in processing unit 310. Alternatively to a serial bus, the receiver may comprise a parallel bus receiver.

Processing unit 310, memory 320, transmitter 330, receiver 340 and/or UI 350 may be interconnected by electrical leads internal to apparatus 300 in a multitude of different ways. For example, each of the aforementioned devices may be separately connected to a master bus internal to apparatus 300, to allow for the devices to exchange information. However, as the skilled person will appreciate, this is only one example and depending on the embodiment various ways of interconnecting at least two of the aforementioned devices may be selected without departing from the scope of the present invention

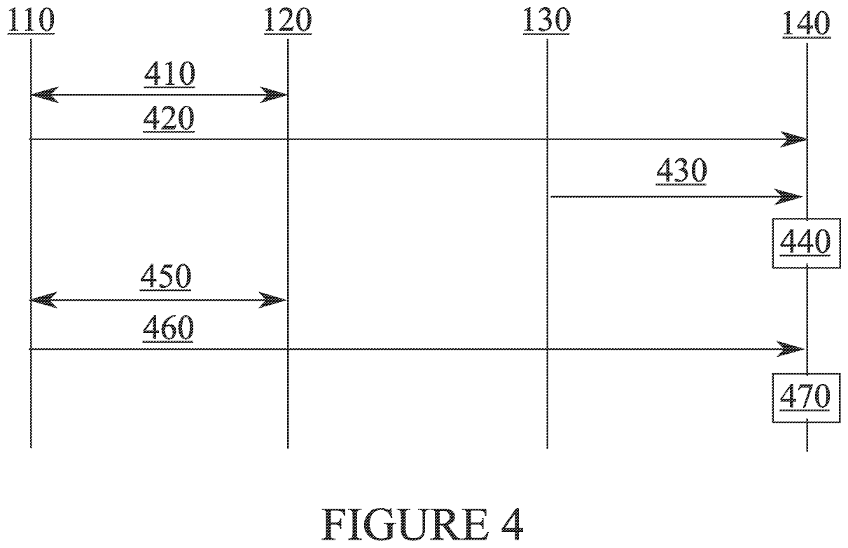

FIG. 4 illustrates a process in accordance with at least some embodiments. On the vertical axes are disposed, from the left to the right, radar 110, target 120, sensor 130 and apparatus 140 of FIG. 1.

At step 410, radar 110 may transmit first electromagnetic signal 112. First electromagnetic signal 112 may hit object 120 for example and consequently, first electromagnetic signal 112 may get reflected back to radar 110. Thus, at step 410, radar 110 may also receive reflected electromagnetic signal of first electromagnetic signal 112, such as first reflected signal 114. Upon reception of first reflected signal 114, radar 110 may transmit, at step 420, first reflected signal 114 to apparatus 140. At step 420, radar 110 may also transmit a time stamp of first reflected signal 114, the time stamp defining a time when first reflected signal 114 was received.

In some embodiments, sensor 130 may transmit, at step 430, a reference signal associated with, or of, first reflected signal 114. Thus, apparatus 140 may determine the reference signal of first reflected signal 114 based on the reference signal received from sensor 130 for providing an accurate magnitude and angle image. However, in some embodiments, apparatus 140 may determine the reference signal of first reflected signal 114 without receiving any information from sensor 130. That is to say, in some embodiments, sensor 130 may be absent to enable simpler and cost-efficient implementation. Apparatus 140 may for example determine the reference signal of first reflected signal 114 from a simulated reference signal. So reception of the reference signal at step 430 is an optional feature.

The reference signal of first reflected signal 114 may be associated with a time stamp as well. For instance, apparatus 140 may receive the time stamp of the reference signal from sensor 130 along with the reference signal. The reference signal may serve as a ground truth, i.e., gold standard, for first reflected signal 114. Apparatus 140 may for example compare the time stamp of first reflected signal 114 and the time stamp of the reference signal and determine, based on the comparison, that the reference signal may be used as the ground truth for first reflected signal 114 if the time stamps are about the same, i.e., within a certain threshold. Thus, the time stamp of first reflected signal 114 and the time stamp of the reference signal of first reflected signal 114 may be compared to enable proper operation of the artificial neural network.

So at step 440, apparatus 140 may determine the reference signal of first reflected signal 114. In addition, apparatus 140 may train an artificial neural network using the reference signal of first reflected signal 114 and first reflected signal 114. Apparatus 140 may for example determine a difference between an output of the artificial network associated with first reflected signal 114 and the reference signal of first reflected signal 114, and train the artificial neural network using the difference. The training process may be referred to as a learning process or an optimization process as well.

For instance, apparatus 140 may feed, or transmit, the reference signal of first reflected signal 114 to an input layer of the artificial neural network and determine an output of the artificial neural network associated with first reflected signal 114 from an output layer of the artificial neural network. Training may be considered as complete if additional observations, such as additional first reflected signals and associated reference signals, do not reduce an error rate, even though the error rate may not reach 0 in all practical applications. In any case multiple first reflected signals 114 and corresponding reference signals may be used for training the artificial neural network, wherein each first reflected signal 114 is associated with a particular reference signal.

Based on the training, the artificial neural network may determine, i.e., select, at least one algorithm for radar 110 at step 440 and provide the selected at least one algorithm as an output. The at least one algorithm may be for example a mirroring algorithm described in Finnish patent application 18206721.5, the Burg algorithm, interpolation algorithm and/or extrapolation algorithm. That is to say, the neural network may select at least one algorithm which provides the highest angular resolution.

Alternatively, or in addition, the artificial neural network may determine, at step 440, a common algorithm for radar 110. The common algorithm may be referred to as an algorithm modelled by the artificial neural network. The common algorithm may be modelled based on training with first reflected signal 114 and thus, the common algorithm may be associated with first reflected signal 114. If the common algorithm is used, apparatus 140 may feed, or transmit, second reflected signal 118 to the artificial neural network and the artificial neural network may provide as the output the magnitude and angle image of radar 110 associated with second reflected signal 118.

The common algorithm may be suitable for various environments and provide the highest angular resolution for radar 110 in general. The common algorithm may be ideal in all circumstances and environments contrary to a Burg algorithm for example, because the Burg algorithm is typically optimal only in some circumstances and environments.

In some embodiments, the artificial neural network may look for parameters for an algorithm, such as the mirroring algorithm, the Burg algorithm, interpolation algorithm and/or extrapolation algorithm, and provide the parameters as an output associated with first reflected signal 114. Apparatus 140 may then determine the magnitude and angle image of radar 110 associated with second reflected signal 118 based on the parameters.

Moreover, in some embodiments, the artificial neural network may provide weights for the algorithms and provide the weights as an output associated with first reflected signal 114. For instance, if a first algorithm is the mirroring algorithm and a second algorithm is the Burg algorithm, the artificial neural network may determine a first weight and a second weight, the first weight being for the first algorithm and the second weight being for the second algorithm. Thus, outputs of various algorithms may be combined depending on the weights, e.g., an output of the first algorithm may be weighted by the first weight and an output of the second algorithm may be weighted by the second weight and the weighted outputs may be then combined.

At step 450, radar 110 may transmit second electromagnetic signal 116. Second electromagnetic signal 116 may also hit object 120, possibly in a different location though, or another object. Second electromagnetic signal 116 may then get reflected back to radar 110. So similarly as at step 410, radar 110 may receive reflected electromagnetic signal of second electromagnetic signal 116, such as second reflected signal 118, at step 450. Upon reception of second reflected signal 118, radar 110 may transmit, at step 460, second reflected signal 118 to apparatus 140.

At step 470, apparatus 140 may, upon receiving second reflected signal 118, provide a magnitude and angle image of radar 110 associated with second reflected signal 118 at step 470, based on the output of the artificial neural network, wherein the output is associated with first reflected signal 114. In some embodiments, the magnitude and angle image of radar 110 associated with second reflected signal 118 may be the output of the artificial neural network if the common algorithm is used. The output of the artificial neural network associated with second reflected signal 118 may be therefore based on, i.e., associated with the common algorithm which may be further based on training with first reflected signal 114. The magnitude and angle image of radar 110 associated with second reflected signal 118 may be provided via UI 350 for example.

In some embodiments, apparatus 140 may obtain from the artificial neural network the at least one algorithm selected by the artificial neural as the output of the artificial neural network associated with first reflected signal 114 and determine the magnitude and angle image of the radar associated with second reflected signal 118 based on the at least one algorithm obtained from the artificial neural network.

In some embodiments, apparatus 140 may obtain from the artificial neural network at least one parameter of the selected at least one algorithm as the output of the artificial neural network associated with first reflected signal 114, wherein the at least one parameter may be modelled by the artificial neural network and determine the magnitude and angle image of radar 110 associated with second reflected signal 118 based on the at least one parameter. That is to say, the output of the artificial neural network may comprise the at least one parameter selected by the artificial neural network.

In some embodiments, apparatus 140 may obtain from the artificial neural network the first and the second weights as the output of the artificial neural network associated with first reflected signal 114, wherein the first weight and the second weights may be associated with a first and a second algorithm, respectively. The first and the second weights may be modelled by the neural network and used to determine the magnitude and angle image of radar 110 associated with second reflected signal 118.

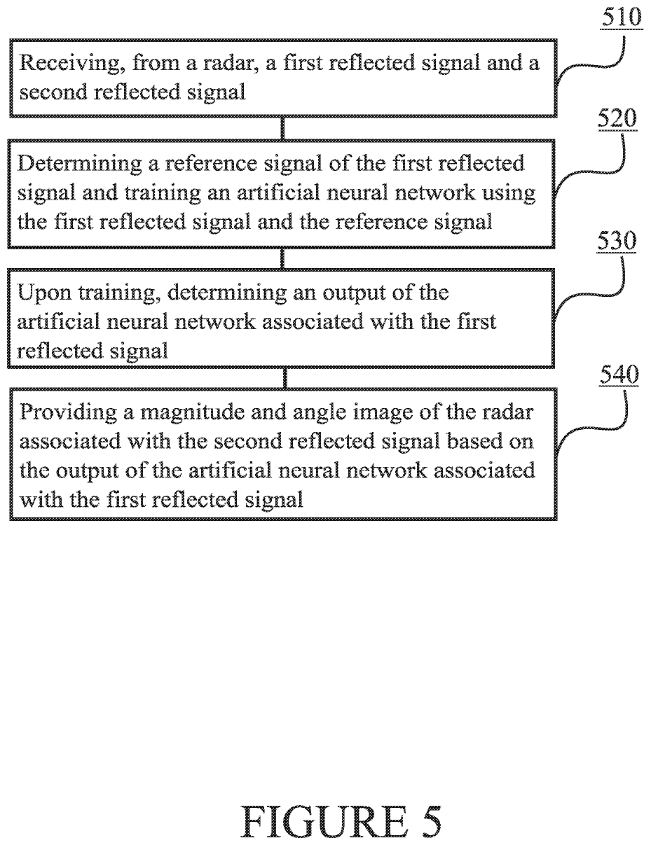

FIG. 5 illustrates a flow graph of a method in accordance with at least some embodiments of the present invention. The phases of the illustrated method may be for an apparatus, e.g., performed by apparatus 140, such as an apparatus for radar 110, or by a control device configured to control the functioning thereof, possibly when installed therein. Apparatus 140 may comprise means for performing, or be configured to perform, the illustrated method. Also, there may be a computer program configured to perform the illustrated method.

The method may comprise, at step 510, receiving, from a radar, a first reflected signal and a second reflected signal. The method may also comprise, at step 520, determining a reference signal of the first reflected signal, and training an artificial neural network using the first reflected signal and the reference signal of the first reflected signal. Upon training, the method may comprise, at step 530, determining an output of the artificial neural network associated with the first reflected signal. Finally, the method may comprise, at step 540, providing a magnitude and angle image of the radar associated with the second reflected signal based on the output of the artificial neural network associated with the first reflected signal.

Embodiments of the present invention therefore provide dynamic beamforming using an artificial neural network. That is to say, for example an algorithm for determining the magnitude and angle image of radar 110 may be selected dynamically (the artificial neural network may provide as an output for example “use the Burg algorithm”), possibly along with a parameter of the algorithm, depending on, e.g., the environment and/or object 120. Moreover, if for example two algorithms are selected, outputs of the selected algorithms may be weighted dynamically based on the environment and/or object upon training of the artificial neural network, i.e., based on the weights selected by the artificial neural network.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

In an exemplary embodiment, an apparatus, such as, for example, apparatus 130, may comprise means for carrying out the embodiments described above and any combination thereof.

In an exemplary embodiment, a computer program may be configured to cause a method in accordance with the embodiments described above and any combination thereof. In an exemplary embodiment, a computer program product, embodied on a non-transitory computer readable medium, may be configured to control a processing unit to perform a process comprising the embodiments described above and any combination thereof.

In an exemplary embodiment, an apparatus, such as, for example, apparatus 130, may comprise at least one processing unit, and at least one memory including computer program code, wherein the at least one memory and the computer program code are configured to, with the at least one processing unit, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in radar systems.

### ACRONYMS LIST

ASIC Application-Specific Integrated Circuit
FMCW Frequency-Modulated Continuous Wave
FPGA Field-Programmable Gate Array
MIMO Multiple-Input Multiple-Output
OFDM Orthogonal Frequency Division Multiplexing
RAM Random-Access Memory
UI User Interface

REFERENCE SIGNS LIST

| | |
|---|---|
| 110 | Radar |
| 112, 116 | Transmitted signals |
| 114, 118 | Reflected signals |
| 120 | Object |
| 130 | Sensor |
| 140 | Apparatus |
| 300-350 | Structure of the apparatus of FIG. 3 |
| 410-470 | Steps in FIG. 4 |
| 510-530 | Phases of the method of FIG. 5 |

1. A method, comprising:
receiving, from a radar, a first reflected signal and a second reflected signal;
determining a reference signal of the first reflected signal and training an artificial neural network using the first reflected signal and the reference signal of the first reflected signal;
upon training, determining an output of the artificial neural network associated with the first reflected signal; and
providing a magnitude and angle image of the radar associated with the second reflected signal based on the output of the artificial neural network associated with the first reflected signal.

2. The method according to claim 1, wherein the method is for an apparatus comprising the artificial neural network.

3. The method according to claim 1, further comprising:
transmitting the second reflected signal as an input to the artificial neural network; and
receiving the output of the artificial neural network, wherein the output comprises the magnitude and angle image of the radar associated with the second reflected signal.

4. The method according to claim 3, wherein the magnitude and angle image of the radar associated with the second reflected signal is determined by the artificial neural network using an algorithm modelled by the artificial neural network during said training.

5. The method according to claim 1, further comprising:
receiving the reference signal from a three-dimensional sensor, the three-dimensional sensor being associated with the radar.

6. The method according to claim 1, further comprising:
determining the reference signal from a simulated reference signal.

7.-17. (canceled)

18. A computer program product, embodied on a non-transitory computer readable medium, configured to control a processing unit to perform a process comprising:
receiving, from a radar, a first reflected signal and a second reflected signal;
determining a reference signal of the first reflected signal and training an artificial neural network using the first reflected signal and the reference signal of the first reflected signal;
upon training, determining an output of the artificial neural network associated with the first reflected signal; and
providing a magnitude and angle image of the radar associated with the second reflected signal based on the output of the artificial neural network associated with the first reflected signal.

19. (canceled)

20. An apparatus comprising at least one processing unit, and at least one memory including computer program code, wherein the at least one memory and the computer program code are configured to, with the at least one processing unit, cause the apparatus at least to:
receive, from a radar, a first reflected signal and a second reflected signal;
determine a reference signal of the first reflected signal and train an artificial neural network using the first reflected signal and the reference signal of the first reflected signal;
upon training, determine an output of the artificial neural network associated with the first reflected signal; and
provide a magnitude and angle image of the radar associated with the second reflected signal based on the output of the artificial neural network associated with the first reflected signal.

21. The apparatus according to claim 20, further comprising the artificial neural network.

22. The apparatus according to claim 20, wherein the the at least one memory and the computer program code are further configured to, with the at least one processing core, cause the apparatus at least to:
transmit the second reflected signal as an input to the artificial neural network; and
receive the output of the artificial neural network, wherein the output comprises the magnitude and angle image of the radar associated with the second reflected signal.

23. The apparatus according to claim 22, wherein the magnitude and angle image of the radar associated with the second reflected signal is determined by the artificial neural network using an algorithm modelled by the artificial neural network during said training.

24. The apparatus according to claim 20, wherein the the at least one memory and the computer program code are further configured to, with the at least one processing core, cause the apparatus at least to:
receive the reference signal from a three-dimensional sensor, the three-dimensional sensor being associated with the radar.

25. The apparatus according to claim 20, wherein the the at least one memory and the computer program code are further configured to, with the at least one processing core, cause the apparatus at least to:
determine the reference signal from a simulated reference signal.

26. The apparatus according to claim 20, wherein the the at least one memory and the computer program code are further configured to, with the at least one processing core, cause the apparatus at least to:
determine a difference between an output of the artificial network associated with the first reflected signal and the reference signal; and
train the neural network using the difference.

27. The apparatus according to claim 20, wherein the the at least one memory and the computer program code are further configured to, with the at least one processing core, cause the apparatus at least to:
train the artificial neural network by providing the first reflected signal to an input layer of the artificial neural network; and
determine the output of the artificial network associated with the first reflected signal from an output layer of the artificial neural network.

28. The apparatus according to claim 20, wherein the output of the artificial neural network comprises an indication about at least one algorithm selected by the artificial neural network, and the the at least one memory and the computer program code are further configured to, with the at least one processing core, cause the apparatus at least to:
determine the magnitude and angle image of the radar associated with the second reflected signal based on the at least one algorithm selected by the artificial neural network.

29. The apparatus according to claim 28, wherein the at least one algorithm comprises a mirroring algorithm, the Burg algorithm, interpolation and/or extrapolation.

30. The apparatus according to claim 28, wherein the output of the artificial neural network comprises at least one parameter selected by the artificial neural network for the at least one algorithm, and wherein the the at least one memory and the computer program code are further configured to, with the at least one processing core, cause the apparatus at least to:
determine the magnitude and angle image of the radar associated with the second reflected signal based on the at least one parameter.

31. The apparatus according to claim 20, wherein an output of a first algorithm associated with the second reflected signal is weighted by a first weight and an output of a second algorithm is weighted by a second weight and the magnitude and angle image of the radar is determined by combining the weighted output of the first algorithm and the weighted output of the second algorithm.

32. The apparatus according to claim 31, wherein the first weight and the second weight are modelled by the artificial neural network.
